(19) United States
(12) Patent Application Publication
(10) Pub. No.: US 2008/0195534 A1
(43) Pub. Date: Aug. 14, 2008

(54) Method for paying an obligation

(75) Inventors: Dean Landis, New York, NY (US); James Ricchiuti, Briarcliff Manor, NY (US)

Correspondence Address: AMSTER, ROTHSTEIN & EBENSTEIN LLP, 90 PARK AVENUE, NEW YORK, NY, 10016, US

(73) Assignee: Credit Cash, LLC

(21) Appl. No.: 11/705,835

(22) Filed: Feb. 12, 2007

(51) Int. Cl. G06Q 40/00

(52) U.S. Cl. 705/39

(57) ABSTRACT

A method for paying an obligation to a lender including the steps of: generating transaction settlement proceeds based on sales made by a merchant; depositing the transaction settlement proceeds in a first bank account, the first bank account being controlled by the lender; sweeping the deposited transaction settlement proceeds to a second bank account; and applying at least a portion of the swept transaction settlement proceeds in the lender's second bank account as a payment on the obligation.

### FIELD OF THE INVENTION

The present disclosure relates to methods of paying an obligation.

### BACKGROUND OF THE INVENTION

In an effort to raise capital, companies may establish bank lines, pledge assets, and even use their owner's homes as collateral. Recently, companies have begun leveraging their future credit card receipts to increase working capital through merchant finance companies. Although using future credit card receipts to increase capital has resulted in many success stories, this financing technique has often been viewed as a last resort because of its high cost and short payback period.

Another disadvantage of conventional merchant finance companies is that they typically require the merchant to switch to a processor selected by the merchant finance company. This disrupts any relationship the merchant may have had with the merchant's previous processor company, and may result in the merchant paying higher fees with lower quality of service depending on the new processor company chosen by the merchant finance company.

Further, most merchant finance companies charge fees for providing advances, and are able to disguise the actual cost of the funds by stressing that the advances are not loans. Thus, the merchant does not know the real value of the financing provided by the merchant finance company, and can not make an informed decision on whether to seek financing elsewhere.

A disadvantage of conventional merchant financing methods from the point of view of the merchant financer is that the merchant may have previously granted a lien and security interest in and to certain of its assets to other creditors, which may leave the funds in the merchant operating account vulnerable to a senior security interest. In this regard, according to the current Uniform Commercial Code (UCC), a prior filer's security interest in the merchant's accounts receivable or deposit accounts may be senior in priority to the merchant financer's subsequent interest in credit card receivables and proceeds. Thus, the merchant financer may not be able to collect on the loan if a senior security interest attaches to the funds deposited in the merchant account.

Accordingly, there is a need for a merchant financing method that uses asset-based lending principles to provide relatively low cost financing, while also allowing merchants to continue using already in-service processors and allowing the lender to collect free and clear of UCC security interests.

### SUMMARY OF THE INVENTION

A method for paying an obligation to a lender according to an exemplary embodiment of the present invention comprises the steps of: generating transaction settlement proceeds based on sales made by a merchant; depositing the transaction settlement proceeds in a first bank account, the first bank account being controlled by the lender; sweeping the deposited transaction settlement proceeds to a second bank account; and applying at least a portion of the swept transaction settlement proceeds in the second bank account as a payment on the obligation.

According to at least one embodiment, the method further comprises depositing the remaining portion of the swept transaction settlement proceeds from the second bank account into the merchant's operating bank account.

According to at least one embodiment, the first bank account is owned by the merchant.

According to at least one embodiment, the transaction settlement proceeds comprise credit card sales proceeds, charge card sales proceeds or smart card sales proceeds.

According to at least one embodiment, the step of generating transaction settlement proceeds comprises processing the sales through a card processor.

According to at least one embodiment, the step of depositing the transaction settlement proceeds in the first bank account is done automatically by the processor.

According to at least one embodiment, the step of sweeping is performed on a periodic basis.

According to at least one embodiment, the periodic basis is daily.

According to at least one embodiment, the remaining portion of the swept transaction settlement proceeds is deposited in the merchant's operating bank account through an automatic clearing house transfer.

According to at least one embodiment, the remaining portion of the swept transaction settlement proceeds is deposited in the merchant's operating bank account by a wire transfer.

A method for collecting a payment on an obligation according to an exemplary embodiment of the present invention comprises the steps of: sweeping deposited transaction settlement proceeds based on sales made by a merchant to a first bank account; and applying at least a portion of the swept transaction settlement proceeds as a payment on the obligation.

According to at least one embodiment, the method further comprises depositing the remaining portion of the swept transaction settlement proceeds into the merchant's operating bank account.

A method for paying an obligation to a lender according to another exemplary embodiment of the present invention comprises the steps of: generating transaction settlement proceeds based on sales made by a merchant; depositing the transaction settlement sales proceeds in the merchant's operating bank account; and automatically deducting at least a portion of the transaction settlement sales proceeds from the merchant's operating bank account as a payment on the obligation to the lender's bank account.

According to at least one embodiment, the step of automatically deducting at least a portion of the transaction settlement sales proceeds comprises determining an amount of funds to be deducted based on the transaction settlement sales proceeds processed by a card processor.

According to at least one embodiment, the step of automatically deducting at least a portion of the transaction settlement sales proceeds comprises determining an amount of funds to be deposited based on the transaction settlement sales proceeds deposited in the merchant's bank account.

According to at least one embodiment, the step of automatically deducting at least a portion of the transaction settlement sales proceeds from the merchant's operating account comprises initiating an automated clearing house transfer from the merchant's operating account to the lender's account.

According to an exemplary embodiment of the present invention, a computer readable medium has computer executable instructions for performing a method for paying an obligation to a lender, and the method includes the steps of: calculating an amount of funds swept into a first bank account to be applied as a payment on the obligation; and separating the funds into a first portion intended as the payment on the obligation and a second portion intended for a second bank account.

These and other features of this invention are described in, or are apparent from, the following detailed description of various exemplary embodiments of this invention.

### BRIEF DESCRIPTION OF THE FIGURES

Various exemplary embodiments of the invention will be described in detail, with reference to the following figures, wherein:

FIG. 1 is a flowchart showing a method for paying an obligation to a lender according to an exemplary embodiment of the present invention;

FIG. 2 is a block diagram showing a merchant finance company computer system according to an exemplary embodiment of the present invention; and

FIG. 3 is a flowchart showing a method for paying an obligation to a lender according to another exemplary embodiment of the present invention.

### DETAILED DESCRIPTION OF PREFERRED EMBODIMENTS

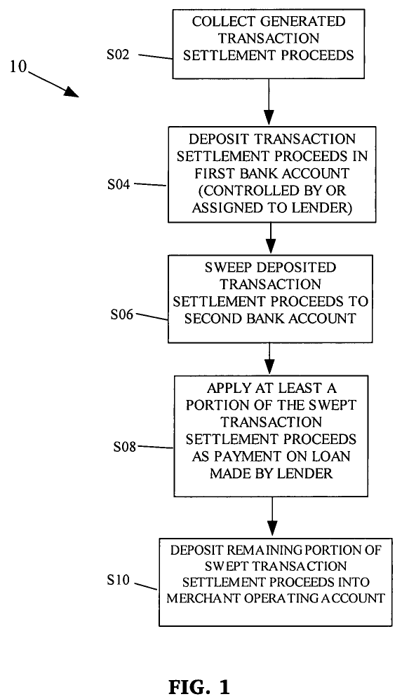

FIG. 1 is a flowchart showing a method, generally designated by reference number 10, for paying an obligation to a lender according to an exemplary embodiment of the present invention. The obligation may be based on, for example, a loan extended by the lender to a merchant, where the amount of the loan is based on the merchant's estimated future transaction settlement proceeds. The term “transaction settlement proceeds” as used herein refers to proceeds that are represented as funds due to the merchant as a result of sales made by the merchant, and may include, for example, credit card sales proceeds, debit card sales proceeds, charge card sales proceeds and smart card sales proceeds.

In step S02 of the method 10, one or more transaction settlement proceeds based on sales made by a merchant are collected. In the case of a credit, debit, charge or smart card, sales may be processed through a card processor, as is known in the art, which results in the collection of credit, debit, charge or smart card sales proceeds. For example, if the card being used is a VISA credit card, the credit card sale may be processed through a VISA card processor that sends a customer's identification information to VISA credit card services along with the sale information, resulting in credit card proceeds being sent back to the VISA card processor in the amount of the sale made by the merchant to the customer.

After the one or more transaction settlement proceeds are collected in step S02, the method 10 proceeds to step S04, where the transaction settlement proceeds are deposited in a first bank account. The first bank account is preferably owned by the merchant, and controlled by or assigned to the lender. Thus, the first bank account may be considered a “lockbox” account because the merchant does not have access to the funds in the first bank account.

The method 10 then proceeds to step S06, where the transaction settlement proceeds are swept into a second bank account. The transaction settlement proceeds may be swept into the second bank account on a periodic basis, such as, for example, on a daily basis. The second bank account is preferably owned by the lender.

In step S08, a percentage of the transaction settlement proceeds that were swept into the second bank account are applied as a payment on the loan. The percentage is preferably a fixed percentage set out as one of the terms of the loan. For example, the merchant may agree that 10% of the transaction settlement proceeds will be applied as a payment on the loan.

After a payment is made to the loan, the method 10 proceeds to step S10, where the remaining funds in the second bank account are deposited in the merchant's operating account. The deposit into the merchant's operating account may be made by either automatic clearing house transfer or direct wire transfer. Depositing of the remaining funds may be made upon the merchant's request, or automatically after the agreed percentage is applied as a payment on the loan.

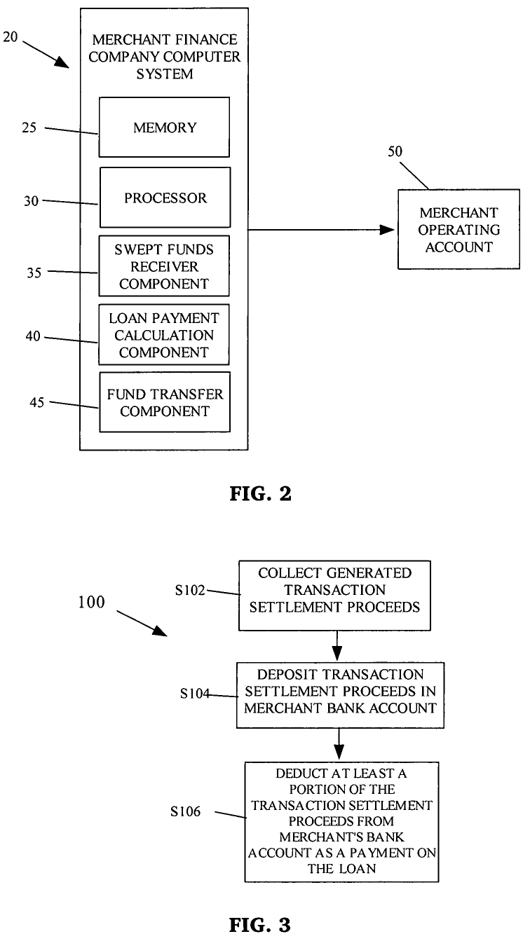

The calculation of the amount of transaction settlement proceeds to be applied as payment on a loan may be done by the lender's computer system after the transaction settlement proceeds are swept into the lender's bank account. FIG. 2 is a block diagram showing a merchant finance company computer system, generally designated by reference number 20, including a memory unit 25, a processor 30, a swept funds receiver component 35, a loan payment component 40, and a fund transfer component 45. The processor 30 receives program instructions and processes data as necessary for the various components of the computer system 20 to carry out their functions. For example, the processor 30 may receive instructions from software implemented on the computer system 20, and the various components may be elements of the program embodied within the software.

The swept funds receiver component 35 tracks the amount of funds periodically swept into the merchant finance company bank account. The loan payment component 40 calculates the amount of the swept funds to be applied as a payment on the loan based on the agreed percentage, and applies that amount to the loan. The funds transfer component 45 deposits the remaining funds from the merchant finance bank account into the merchant operating account 50 after the loan payment component 40 applies a portion of the swept funds as a payment on the loan. Alternatively, the loan payment component 40 may split the swept transactions settlement proceeds into a first portion intended as a payment on the loan and a second portion intended for the merchant's operating account, and then place the first and second portions into a queue for later manual distribution of the funds.

FIG. 3 is a flowchart showing a method, generally designated by reference number 100, for paying an obligation to a lender according to another exemplary embodiment of the present invention. In step S102 of the method 100, transaction settlement proceeds generated based on sales made by a merchant are collected. In the case of a credit, debit, charge or smart card, sales may be processed through a card processor, as is known in the art, which results in the collection of credit, debit, charge or smart card sales proceeds. In step S104, the transaction settlement proceeds are deposited in the merchant's operating bank account. Then, in step S106, at least a portion of the transaction settlement proceeds are deducted from the merchant's operating bank account as a payment on the obligation to the lender's bank account. As in the previous embodiment, an agreed percentage of the transaction settlement proceeds may be deducted as a payment on the loan. The deduction of at least a portion of the transaction settlement proceeds from the merchant's operating account may be accomplished by the lender initiating an automated clearing house transfer from the merchant's operating account in the agreed upon amount. In the case of credit, debit, charge or smart card sales, the amount to be deducted may be calculated based on the transaction settlement proceeds generated by the card processor before being deposited into the merchant's bank account or after being deposited into the merchant's bank account.

In addition to an agreed percentage to be deducted from the transaction settlement proceeds, the merchant finance agreement between the lender and merchant may also include other provisions, such as, for example, a true-up provision and a re-load option. A true-up provision authorizes the lender to increase the payment percentage. For example, if the merchant's sales and/or cash receipts from a card processor for any given month are down by 10% or more (or by some other agreed upon percentage) from the comparative period one year earlier, the lender may increase the payment percentage in an amount sufficient to equal the amount of proceeds the lender would have received based on the merchant's sales and/or cash receipts from the card processor in the period one year earlier. The re-load option gives the merchant an option to receive additional loaned funds from the lender at the end of either the original loan period or an agreed upon earlier period, for which the merchant can continue to make payments using transaction settlement proceeds based on the original loan terms or new loan terms.

While the foregoing invention has been described in some detail for purposes of clarity and understanding, it will be appreciated by one skilled in the art from a reading of the disclosure that various changes in form and detail can be made without departing from the true scope of the invention in the appended claims.

What is claimed is:

1. A method for paying an obligation to a lender, comprising:
generating transaction settlement proceeds based on sales made by a merchant;
depositing the transaction settlement proceeds in a first bank account, the first bank account being controlled by the lender;
sweeping the deposited transaction settlement proceeds to a second bank account; and
applying at least a portion of the swept transaction settlement proceeds in the second bank account as a payment on the obligation.

2. The method of claim 1, further comprising depositing the remaining portion of the swept transaction settlement proceeds from the second bank account into the merchant's operating bank account.

3. The method of claim 1, wherein the first bank account is owned by the merchant.

4. The method of claim 1, wherein the transaction settlement proceeds comprise credit card sales proceeds, charge card sales proceeds or smart card sales proceeds.

5. The method of claim 4, wherein the step of generating transaction settlement proceeds comprises processing the sales through a card processor.

6. The method of claim 5, wherein the step of depositing the transaction settlement proceeds in the first bank account is done automatically by the processor.

7. The method of claim 1, wherein the step of sweeping is performed on a periodic basis.

8. The method of claim 7, wherein the periodic basis is daily.

9. The method of claim 2, wherein the remaining portion of the swept transaction settlement proceeds is deposited in the merchant's operating bank account through an automatic clearing house transfer.

10. The method of claim 2, wherein the remaining portion of the swept transaction settlement proceeds is deposited in the merchant's operating bank account by a wire transfer.

11. A method for collecting a payment on an obligation, comprising:
sweeping deposited transaction settlement proceeds based on sales made by a merchant to a first bank account; and
applying at least a portion of the swept transaction settlement proceeds as a payment on the obligation

12. The method of claim 11, further comprising depositing a remaining portion of the swept transaction settlement proceeds in the merchant's operating bank account.

13. The method of claim 11, wherein the step of sweeping is performed on a periodic basis.

14. The method of claim 13, wherein the periodic basis is daily.

15. The method of claim 12, wherein the remaining portion of the swept transaction settlement proceeds is deposited in the merchant's operating bank account through an automatic clearing house transfer.

16. The method of claim 12, wherein the remaining portion of the swept transaction settlement proceeds is deposited in the merchant's operating bank account by a wire transfer.

17. The method of claim 11, wherein the transaction settlement proceeds comprise credit card sales proceeds, charge card sales proceeds or smart card sales proceeds.

18. A method for paying an obligation made by a merchant to a lender, comprising:
generating transaction settlement proceeds based on sales made by a merchant;
depositing the transaction settlement proceeds in the merchant's operating bank account; and
automatically deducting at least a portion of the transaction settlement proceeds from the merchant's operating bank account as a payment on the obligation to the lender's bank account.

19. The method of claim 18, wherein the transaction settlement proceeds comprise credit card sales proceeds, charge card sales proceeds or smart card sales proceeds.

20. The method of claim 19, wherein the step of generating transaction settlement proceeds comprises processing the sales through a card processor.

21. The method of claim 20, wherein the step of depositing the transaction settlement proceeds in the merchant's bank account is done automatically by the card processor.

22. The method of claim 20, wherein the step of automatically deducting at least a portion of the transaction settlement proceeds comprises determining an amount of funds to be deducted based on the transaction settlement proceeds generated by the processor.

23. The method of claim 20, wherein the step of automatically deducting at least a portion of the transaction settlement proceeds comprises determining an amount of funds to be deducted based on the transaction settlement proceeds deposited in the merchant's bank account.

24. The method of claim 18, wherein the step of automatically deducting at least a portion of the transaction settlement proceeds comprises initiating an automated clearing house transfer from the merchant's operating account to the lender's bank account.

25. A computer readable medium having computer executable instructions for performing a method for paying an obligation to a lender, the method comprising the steps of:
calculating an amount of funds swept into a first bank account to be applied as a payment on the obligation; and
separating the funds into a first portion intended as the payment on the obligation and a second portion intended for a second bank account.

26. The computer readable medium of claim 25, further comprising placing the first portion and second portion of the funds into a queue for manual distribution.

27. The computer readable medium of claim 25, wherein the first bank account is owned by the lender.
